(19) United States
(12) Patent Application Publication
(10) Pub. No.: US 2025/0274821 A1
(43) Pub. Date: Aug. 28, 2025

(54) Handling Successful Handover Reporting (SHR) Configuration at UE and Network

(71) Applicant: Telefonaktiebolaget LM Ericsson (publ), Stockholm (SE)

(72) Inventors: Ali Parichehrehteroujeni, Linköping (SE); Pradeepa Ramachandra, Linköping (SE); Marco Belleschi, Solna (SE)

(21) Appl. No.: 18/704,965

(22) PCT Filed: Oct. 9, 2022
(86) PCT No.: PCT/SE2022/050910

§ 371 Date: Apr. 26, 2024

Related U.S. Application Data
(60) Provisional application No. 63/273,193, filed on Oct. 29, 2021.

(51) Int. Cl. H04W 36/00; H04W 76/20

(52) U.S. Cl. CPC H04W 36/0061; H04W 36/0058; H04W 76/20

(57) ABSTRACT

Embodiments include methods for a user equipment (UE) configured to communicate with a first radio access network (RAN) node via a cell. Such methods include receiving, from the first RAN node via the cell, a configuration for successful handover reporting (SHR) by the UE. The configuration for SHR includes a first partial SHR configuration pertaining to a source cell for UE handover, and a second partial SHR configuration pertaining to one or more target cells for UE handover. In some embodiments, the configuration for SHR is valid only while the UE is in a connected state with the RAN, and the UE may discard it in association with entering a non-connected state. Other embodiments include complementary methods for the first RAN node, as well as UEs and RAN nodes configured to perform such methods.

### TECHNICAL FIELD

The present disclosure relates generally to wireless networks, and more specifically to techniques for a network to configure user equipment (UEs) to provide reports about successful handovers in a wireless network, and for UEs to manage and use such configurations.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

FIG. 2 shows a high-level view of an exemplary 5G network architecture, including a NG-RAN 299 and 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to access and mobility management functions (AMFs, e.g., 230a,b) via respective NG-C interfaces and to user plane functions (UPFs, e.g., 240a,b) via respective NG-U interfaces. Moreover, AMFs can communicate with one or more policy control functions (PCFs, e.g., 250a,b) and network exposure functions (NEFs, e.g., 260a,b).

Each of the gNBs can support the NR radio interface including frequency division duplexing (FDD), time division duplexing (TDD), or a combination thereof. Each of ng-eNBs 220 can support the fourth-generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is possible that a single NG-RAN node provides both types of functionality.

Seamless handovers are a key feature of 3GPP technologies. A UE is handed over from a source or serving cell, provided by a source node, to a target cell provided by a target node. Successful handovers ensure that the UE moves around in the coverage area of different cells without causing too many interruptions in the data transmission. However, handover can have various problems related to robustness. For example, a handover command is normally sent when the radio conditions for the UE are already quite bad, and may not reach the UE before the UE's degraded connection with the source node/cell is dropped. There are also various other reasons why a handover triggered for a UE is ultimately successful or unsuccessful.

### SUMMARY

3GPP has agreed to standardize (e.g., for Release 17) a successful handover report (SHR, also referred to as handover success report) that will be sent by the UE to the network upon successful execution of a handover (e.g., reconfiguration with sync). As part of this work, 3GPP has defined a SHR configuration that a UE should apply it when the UE is in an RRC_CONNECTED state, to facilitate reporting information (e.g., measurements) to the network about successful handover under some specific conditions configured by the network. However, there are various problems, issues, and/or difficulties related to SHR configurations, including how the UE should obtain SHR configurations and manage them during transitions to other radio resource control (RRC) states such as RRC_IDLE and RRC_INACTIVE.

Embodiments of the present disclosure provide specific improvements to handover reporting by UEs in a wireless network, such as by providing, enabling, and/or facilitating solutions to exemplary problems summarized above and described in more detail below.

Embodiments include methods (e.g., procedures) for a UE configured to communicate with a first RAN node via a cell.

These exemplary methods can include receiving, from the first RAN node via the cell, a configuration for SHR by the UE. The configuration for SHR includes a first partial SHR configuration pertaining to a source cell for UE handover, and a second partial SHR configuration pertaining to one or more target cells for UE handover.

In some embodiments, the configuration for SHR is valid only while the UE is in a connected state with the RAN. In some of these embodiments, these exemplary methods can also include storing the SHR configuration in UE memory, subsequently entering a non-connected state with the RAN, and discarding the SHR configuration stored in the UE memory in association with entering the non-connected state.

In some of these embodiments, these exemplary methods can also include receiving, from the first RAN node, a command to exit the connected state and to enter a non-connected state with the RAN. In such case, entering the non-connected state can be responsive to the command and discarding the SHR configuration can be responsive to the command or, alternately, to entering the non-connected state. In some variants, the command indicates that the UE should discard the SHR configuration if it is stored by the UE.

In other of these embodiments, entering the non-connected state is responsive to a failure to reestablish a connection with the RAN, e.g., after a radio link failure (RLF). Additionally, discarding the SHR configuration is responsive to the failure or, alternately, to entering the non-connected state.

In some embodiments, discarding the SHR configuration includes discarding the SHR configuration when the non-connected state is RRC_IDLE and retaining the SHR configuration in the UE memory when the non-connected state is RRC_INACTIVE.

In some embodiments, the SHR configuration is received by the UE in a single message. In other embodiments, the first and second partial SHR configurations are received by the UE in respective first and second messages. In some variants, each of the single message, the first message, and the second message is an RRCReconfiguration message.

In some embodiments, the second partial SHR configuration includes respective identifiers of the one or more target cells. In some embodiments, the first partial SHR configuration includes respective first thresholds for one or more timers associated with the cell. In some embodiments, the second partial SHR configuration includes respective second thresholds for respective timers associated with the one or more target cells. In some of these embodiments, the respective first thresholds and/or the respective second thresholds are percentages or fractions of corresponding timer values that are configured for the respective cells.

In some embodiments, these exemplary methods can also include logging measurements in accordance with the SHR configuration during a handover from the cell to one of the target cells, and sending a SHR comprising the logged measurements to a second RAN node.

Other embodiments include methods (e.g., procedures) for a first RAN node configured to communicate with UEs via a cell. These exemplary methods are generally complementary to the UE exemplary methods summarized above.

These exemplary methods can include sending, to a UE via the cell, a configuration for SHR by the UE. The configuration for SHR includes a first partial SHR configuration pertaining to a source cell for UE handover, and a second partial SHR configuration pertaining to one or more target cells for UE handover.

In some embodiments, the SHR configuration is valid only while the UE is in a connected state with the RAN and these exemplary methods also include sending to the UE a command to exit the connected state and to enter a non-connected state with the RAN. In some of these embodiments, the non-connected state is RRC_IDLE or RRC_INACTIVE, such that the command is (or is included in) an RRCRelease message or an RRCSuspend message, respectively. In some of these embodiments, the command indicates that the UE should discard the SHR configuration if it is stored by the UE.

In some embodiments, the cell served by the first RAN node is the source cell and these exemplary methods also include receiving the second partial SHR configuration from a second RAN node that serves cells including the one or more target cells. In some of these embodiments, the second partial SHR configuration is specific to the UE, and is received in response to sending the second RAN node a request to handover the UE to one of the target cells. In other of these embodiments, the second partial SHR configuration is non-specific to the UE, and is received in response sending the second RAN node one of the following:
a partial SHR configuration pertaining to one or more cells served by the first RAN node, including the cell; or
a request for a partial SHR configuration pertaining to cells served by the second RAN node, including the one or more target cells.

In some embodiments, the SHR configuration can be sent to the UE in any of the ways summarized above for UE embodiments, and can have any of content summarized above for UE embodiments.

Other embodiments include UEs (e.g., wireless devices, etc.) and RAN nodes (e.g., base stations, eNBs, gNBs, ng-eNBs, TRPs, etc.) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein can facilitate UE successful handover reporting according to a well-defined SHR configuration while in RRC_CONNECTED state, while avoiding inconsistent and/or undesirable UE behavior upon moving from RRC_CONNECTED state to RRC_IDLE or RRC_INACTIVE state. Availability of useful SHR information facilitates network operational improvements that can benefit UEs performing subsequent handovers.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-B illustrate some reasons why handover of a UE may be unsuccessful.

FIGS. 5-6 are diagrams of signaling between a UE, a source node, and a target node, according to various embodiments of the present disclosure.

FIG. 7 shows a diagram of signaling between a UE and a source node, according to other embodiments of the present disclosure.

FIGS. 8A-B show exemplary ASN.1 data structures, according to various embodiments of the present disclosure.

FIG. 9 shows a flow diagram of an exemplary method (e.g., procedure) for a first RAN node (e.g., base station, eNB, gNB, ng-eNB, etc.), according to various embodiments of the present disclosure.

FIG. 10 shows a flow diagram of an exemplary method (e.g., procedure) for a UE (e.g., wireless device), according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

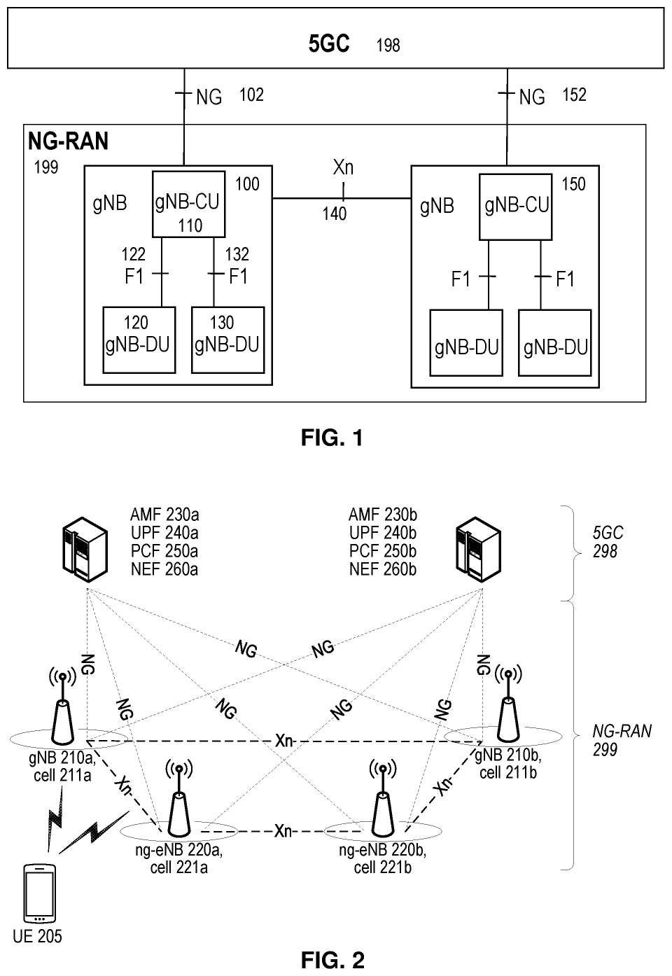

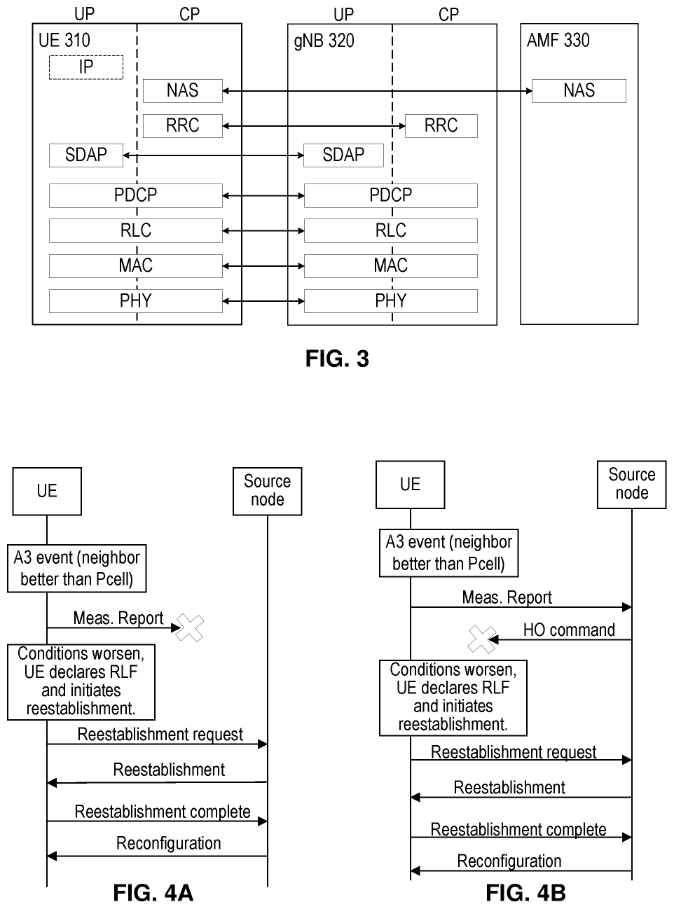

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

Seamless mobility is a key feature of 3GPP radio access technologies (RATs). In general, a network configures a UE to perform and report radio resource management (RRM) measurements to assist network-controlled mobility decisions, such as for handover from a serving cell to a neighbor cell while the UE is in RRC_CONNECTED state. Seamless handovers ensure that the UE moves around in the coverage area of different cells without causing too many interruptions in data transmission.

During preparation for handover of a UE to a target node, the source node sends the current UE configuration to the target node in the HANDOVER REQUEST message. The target node prepares a target configuration for the UE based on the current configuration and the capabilities of the target node and the UE. The target node sends the target configuration to the source node in a HANDOVER REQUEST ACKNOWLEDGE message, which the source node encapsulates in an RRCReconfiguration message to the UE. As a streamlined option, the target configuration can be signaled as a “delta-configuration” including only the differences from the UE's current configuration in the source cell.

Handovers are normally triggered when the UE is at the edge of a cell's coverage and experiences poor radio conditions. Once the UE experiences such conditions, the network may be unable to receive a measurement report from the UE, such that the network will not initiate a handover procedure. Even if the network does receive measurement reports, the UE may be unable to receive the network's handover command (i.e., the RRCReconfiguration message with a reconfigurationWithSync field) due to poor DL radio conditions. Moreover, in poor radio conditions the DL message is often segmented, which increases the likelihood of retransmissions with associated delay. As such, even if the handover command reaches the UE, it may be too late. For these reasons, failed transmission of handover command is a common reason for unsuccessful handovers.

FIG. 4, which includes FIGS. 4A and 4B, illustrates various exemplary robustness problems that can occur during UE mobility operations, such as during a handover. In the scenario shown in FIG. 4A, based on neighbor-cell measurements, the UE triggers an “A3 event” where the neighbor cell is better than the UE's primary cell (PCell). In response, the UE attempts to send a measurement report about this condition to the source (e.g., serving) node. Due to the rapidly degrading uplink radio conditions, however, the source node does not receive the measurement report from the UE. Conditions continue to degrade in the UE's source cell, ultimately prompting the UE to declare RLF and attempt to reestablish a connection with the source node (which may or may not be successful). In FIG. 4B, the source node correctly receives the UE's measurement report but due to degrading downlink radio conditions, the UE does not receive the HO command from the source node. Ultimately, the same result occurs in both cases shown in FIG. 4.

As such, there is a need to improve mobility robustness in NR systems, and 3GPP Rel-16 includes some features called mobility robustness optimization (MRO). The main objectives of MRO are to improve the robustness at handover and to decrease the interruption time at handover. In LTE and NR, different solutions to increase mobility robustness have been discussed in the past. One solution is based on DC introduced in LTE Rel-12. In DC, the UE is connected to two network nodes simultaneously. This improves mobility robustness by serving control plane traffic (e.g., used for measurement reporting and handover command) by a robust macro layer at lower frequency and providing capacity boost with higher frequencies. This feature is often referred to as “UP/CP split.” Alternately, DC can be configured such that control plane signaling is exchanged via both connected nodes. This is referred to as “RRC diversity” and can increase robustness due to the diversity in temporal and spatial domains.

Another solution is called “conditional handover” (or “CHO” for short) or “early handover command.” In CHO, transmission and execution of the handover command are separated. This allows the handover command to be sent earlier to UE when the radio conditions are still good, thus increasing the likelihood that the message is successfully transferred. The execution of the handover command is done at later point in time based on an associated execution condition. The execution condition is typically in the form a threshold, e.g., signal strength of candidate target cell becomes X dB better than the serving cell (“A3 event”) or signal strength of serving cell becomes worse than X dBm and signal strength of candidate target cell becomes better than Y dBm (“A5 event”).

A preceding measurement reporting event could use a threshold Y that is selected to be lower than the one in the handover execution condition. This allows the serving cell to prepare the handover upon reception of an early measurement report and to provide the RRCConnectionReconfiguration with mobilityControlInfo (for LTE), or a RRCReconfiguration with either a reconfigurationWithSync or a CellGroupConfig (for NR) at a time when the radio link between the source cell and the UE is still relatively stable. The execution of the handover is done at a later point in time (and threshold) that is optimal and/or preferred for handover execution.

The concept of a successful handover report (SHR) was described in the 3GPP TR 37.816 (v16.0.0). In general, this concept involves the UE sending additional information to the target cell upon successfully completing a handover. In this way, additional knowledge available at the UE about the radio conditions, failure possibilities, etc. can be provided to the network, which can facilitate tuning handover parameters. Relevant portions of 3GPP TR 37.816 are given below.

*** Begin text from 3GPP TR 37.816 ***

### 5.3.2.5 Successful HO Report

The MRO function in NR could be enhanced to provide a more robust mobility via reporting failure events observed during successful handovers. A solution to this problem is to configure the UE to compile a report associated to a successful handover comprising a set of measurements collected during the handover phase, i.e., measurement at the handover trigger, measurement at the end of handover execution or measurement after handover execution. The UE could be configured with triggering conditions to compile the Successful Handover Report; hence the report would be triggered only if the conditions are met. This limits UE reporting to relevant cases, such as underlying issues detected by RLM, or BFD detected upon a successful handover event.

The availability of a Successful Handover Report may be indicated by the Handover Complete message (RRCReconfigurationComplete) transmitted from UE to target NG-RAN node over RRC. The target NG-RAN node may fetch information of a successful handover report via UE Information Request/Response mechanism. In addition, the target NG-RAN node could then forward the Successful Handover Report to the source NR-RAN node to indicate failures experienced during a successful handover event.

The information contained in the successful handover report may comprise:
RLM related information
RLM related timers (e.g., T310, T312)
Measurements of reference signals used for RLM in terms of RSRP, RSRQ, SINR
RLC retransmission counter
Beam failure detection (BFD) related information
   Detection indicators and counters (e.g., Qin and Qout indications)
   Measurements of reference signals used in BFD in terms of RSRP, RSRQ, SINR
Handover related information
   Measurements of the configured reference signals at the time of successful handover
      SSB beam measurements
      CSI-RS measurements
   Handover related timers (e.g., T304)
   Measurement period indication, i.e., measurements are collected at handover trigger, at the end of handover execution or just after handover execution

Upon reception of a Successful HO Report, the receiving node is able to analyse whether its mobility configuration needs adjustment. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

*** End text from 3GPP TR 37.816 ***

Based on this study related to Rel-16, 3GPP agreed to standardize SHR (also referred to as handover success report) for Rel-17. An SHR will be sent by the UE to the network upon successful execution of a handover (e.g., reconfiguration with sync). 3GPP RAN2 working group (WG) has made the following agreements concerning SHR:
At least the following triggering conditions are applied for generating an HO Success Report in the case that the HO succeeds
   UE logs HO success report if, while doing HO, T310 value exceeds a threshold
   UE logs HO success report if, while doing HO, timer T312 value exceeds a threshold
   UE logs HO success report if, while doing HO, timer T304 exceeds a threshold.
   In case of dual-active protocol stack (DAPS), if the UE gets an RLF in the source cell while doing DAPS.
The source cell and target cell related identifiers and measurements are to be included in the successful HO report.
RAN2 to focus on the following scenarios for HO Success Report
   Scenario 1 (ordinary HO): 1a, 1b
   Scenario 2 (CHO): 2a, 2b
   Scenario 3 (DAPS): 3a
RAN2 to further discuss whether the following scenarios should be considered under the RLF report or under the HO success report: 2c, 3b
The following radio related measurements are as part of the successful HO report:
   Latest radio measurement results of the candidate target cells in the case of conditional HO. FFS best cell(s) should be included in
   Flag to indicate RLF issues in source cell during DAPS HO.
The following time-related measurements are as part of the successful HO report: Time elapsed between the CHO execution towards the target cell and the corresponding latest CHO configuration received for the selected target cell.
Location information is included as part of the successful HO report.
Define separate thresholds for timers T310/T312/T304, and the percentage values are 40%, 60%, 80%. The percentage is to indicate the ratio of the threshold value (unit: ms) over the signalled T310/T312/T304 value (unit: ms). For threshold for T312, the percentage value also includes 20%.
For the thresholds of T310/T312 in the source cell, the source cell configures the values. FFS source cell or target cell can configure the threshold for T304.
Introduce a UE capability indication for SHR.
The UE may discard the SHR (i.e., release the UE variable VarSuccHO-Report) but no sooner than 48 hours after the SHR is stored.
UP measurements for Successful Handover Report will be introduced as RAN3 requires (details for further study).

Additionally, RAN2 has agreed to further discuss the need of the following parameters as part of the successful HO report:
Latest radio link quality of neighbor cells before HO command was received for all HO types.
Configured CHO execution condition(s), e.g. A3 and/or A5 event configuration, of the candidate target cells. The inclusion of this parameter depends on the RAN3 reply to the RAN2 LS R2-2102149.
Radio quality of source cell when ConditionalReconfiguration is received before conditional handover execution condition is satisfied
Latest radio link quality of source cell before HO command was received in the case of DAPS
   Additionally, RAN2 has agreed to further discuss the need of the following time-related measurements as part of the successful HO report:
Elapsed time for T310 timer for normal HO
Elapsed time for T310 timer for Conditional HO

As part of this work, 3GPP has defined a SHR configuration as a configuration that a UE should apply when the UE is in an RRC_CONNECTED state, in order to report information (e.g., measurements) to the network about a successful handover under some specific conditions that are configured by the network, such as those agreements listed above.

However, it is not clear how the UE receives an SHR configuration (e.g., including the configurations and thresholds belonging to the source cell) from source and/or target nodes, or from candidate target nodes serving CHO candidate cells. In addition, currently available techniques do not address the situation where the network sends the UE to RRC_IDLE or RRC_INACTIVE state, in which the SHR configuration is not valid. Retaining an SHR configuration RRC_IDLE or RRC_INACTIVE state may be inconsistent with appropriate UE behavior since the retained configuration may not be valid anymore when UE returns to RRC_CONNECTED state.

Accordingly, embodiments of the present disclosure provide flexible and efficient techniques whereby a UE receives an SHR configuration from source cell and target cell (or CHO candidate cells) in a single RRC message or in successive RRC messages. The UE can store the SHR configuration received in this manner and use it to trigger sending of a SHR whenever needed while operating in RRC_CONNECTED state. In addition, the UE can discard a stored SHR configuration upon moving from RRC_CONNECTED state to RRC_IDLE or RRC_INACTIVE state.

In this manner, embodiments can facilitate UE successful handover reporting according to a well-defined SHR configuration while in RRC_CONNECTED state, while avoiding inconsistent and/or undesirable UE behavior upon moving from RRC_CONNECTED state to RRC_IDLE or RRC_INACTIVE state.

The following description refers to source nodes and target nodes, which in general are RAN nodes such as base stations. These RAN nodes can be LTE nodes (e.g., eNB or ng-eNB), NR nodes (e.g., gNB or en-gNB), or units/functions of such nodes (e.g., CU or DU).

In the following, the terms “successful handover configuration”, “successful handover report configuration”, and “SHR configuration” are used interchangeably and/or synonymously unless specifically noted or unless a different meaning is clear from a specific context of use. All of these terms refer to a configuration sent by the network to a UE that instructs the UE to send a report including information (e.g., measurements) pertaining to a successful execution of a handover (e.g., reconfiguration with sync). For example, such a configuration can include thresholds (e.g., thr_304 for timer T304) that when met (e.g., T304 value is greater than thr_T304) trigger the UE to send a SHR to the network.

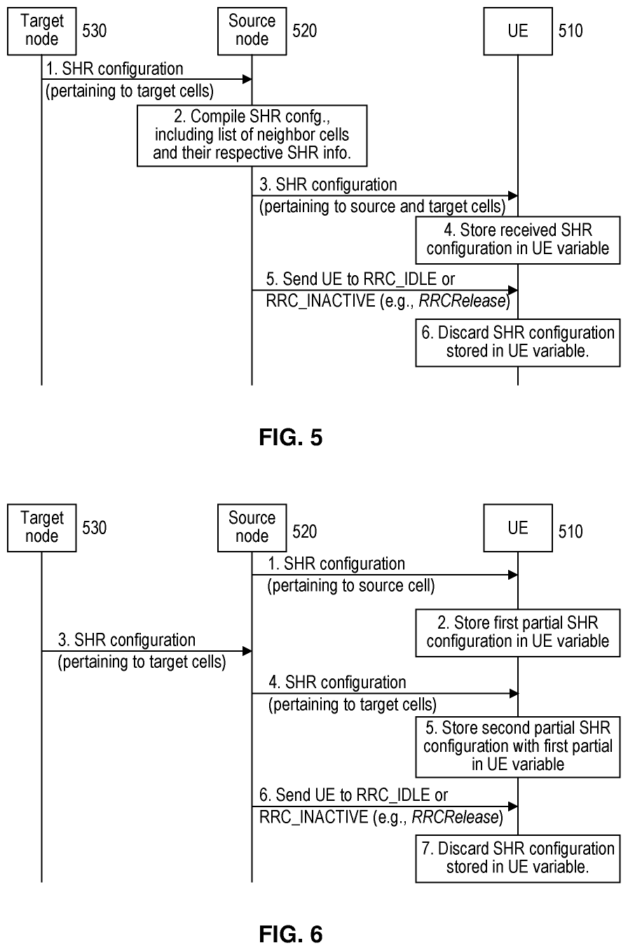

FIG. 5 shows a signaling diagram between a UE (510), a source node (520), and a target node (530) according to some embodiments of the present disclosure. At a high level, these embodiments involve the source node sending the UE a single message containing an SHR configuration. Although FIG. 5 shows operations with numerical labels, these are intended to facilitate explanation rather than to require and/or imply a sequential order of the operations, unless expressly stated otherwise.

In operation 1, the target node sends an SHR configuration to the source node. This SHR configuration pertains to target cells served by the target node. For example, this SHR configuration can include respective thresholds associated with target cells, e.g., timer T304 threshold. Additionally, the SHR configuration can include (or be received together with) respective target cell identifiers, such as PCI (physical cell identity) or CGI (cell global identity).

In some embodiments, the SHR configuration can be a UE-specific SHR configuration sent in response to a HO request sent by the source node to the target node (not shown in FIG. 5). Such embodiments provide flexibility for UE-specific SHR configuration based on UE-specific properties, capabilities, radio conditions, mobility states, etc.

In other embodiments, the SHR configuration sent from target to source can be part of an exchange between these two nodes during an interface (e.g., X2, Xn) setup procedure and/or configuration update procedure such as specified in 3GPP TS 38.423. In such case, the SHR configuration sent by the target node is not UE-specific but rather is generic. Such embodiments reduces the overhead of sending SHR configurations between nodes relative to UE-specific configuration, at the expense of reduced flexibility.

In other embodiments, the target node can send the SHR configuration in operation 1 upon receiving a request from the source node (not shown in FIG. 5). This request may be independent of any UE-specific handover operation.

In some embodiments, the target node can be a candidate target node serving a candidate target cell for a conditional handover of the UE. In these embodiments, the source node can receive a plurality of SHR configurations from a respective plurality of candidate target nodes, with each SHR configuration pertaining to node-specific candidate target cells.

In operation 2, the source node can compile an SHR configuration including the information received in operation 1 and further information related to the UE's current serving (or source cell). For example, this compiled SHR configuration can include thresholds associated with target cells (e.g., timer T304 threshold) and thresholds associated with the source cell (e.g., timer T310 threshold and/or timer T312 threshold).

In operation 3, the source node sends the SHR configuration compiled in operation 2 to the UE. In some embodiments, the SHR configuration is sent as part of an otherConfig IE in an RRCReconfiguration message to the UE, before sending the UE a handover command (e.g., reconfiguration with sync).

In operation 4, the UE stores the SHR configuration received in operation 3 in an appropriate UE variable, such as VarSucessHO-Config. In other words, the UE stores the SHR configuration in an area in UE memory that is assigned to and/or associated with the variable. While the UE is operating in RRC_CONNECTED state, the UE uses the stored SHR configuration to trigger sending of a SHR as appropriate (i.e., when conditions in the SHR configuration are met).

In operation 5, the source node sends the UE a command and/or instruction to leave RRC_CONNECTED state and enter RRC_IDLE or RRC_INACTIVE state. For example, the source node can send the UE an RRCRelease message, which will trigger the UE to release its RRC connection and enter RRC_IDLE state. As another example, the source node can send the UE an RRCSuspend message, which will trigger the UE to suspend its RRC connection and enter RRC_INACTIVE state.

In operation 6, the UE discards the SHR configuration stored in the variable during operation 4 (i.e., if such information is still stored in the variable and was not discarded earlier). In other words, the UE deletes, overwrites, removes, or otherwise makes unusable the SHR configuration previously stored in the area of UE memory that is assigned to and/or associated with the variable. In some embodiments, operation 6 can be responsive to receiving the command and/or instruction in operation 5. In other words, both operation 6 and entering RRC_IDLE or RRC_INACTIVE are responsive to the command and/or instruction. In other embodiments, operation 6 can be done proximately after entering RRC_IDLE or RRC_INACTIVE.

In some variants, the UE can have different behavior in operation 6 depending on whether the command and/or instruction received in operation 5 was to enter RRC_IDLE state or to enter RRC_INACTIVE state. For example, when the command and/or instruction is for RRC_IDLE, the UE can discard the stored SHR configuration. On the other hand, when the command and/or instruction is for RRC_INACTIVE, the UE can retain (or refrain from discarding) the stored SHR configuration.

FIG. 6 shows a signaling diagram between a UE (510), a source node (520), and a target node (530) according to other embodiments of the present disclosure. At a high level, these embodiments involve the source node sending the UE multiple messages that collectively contain an SHR configuration. Although FIG. 6 shows operations with numerical labels, these are intended to facilitate explanation rather than to require and/or imply a sequential order of the operations, unless expressly stated otherwise.

In operation 1, the source node compiles a first partial SHR configuration including information related to the UE's current serving (or source cell). For example, this compiled SHR configuration can include thresholds associated with the source cell (e.g., timer T310 threshold and/or timer T312 threshold). The source node sends the first partial SHR configuration to the UE. In some embodiments, the first partial SHR configuration is sent as part of an otherConfig IE in an RRCReconfiguration message to the UE, before sending the UE a handover command (e.g., reconfiguration with sync).

In operation 2, the UE stores the first partial SHR configuration received in operation 1 in an appropriate UE variable, such as VarSucessHO-Config. In other words, the UE stores the first partial SHR configuration in an area in UE memory that is assigned to and/or associated with the variable, i.e., in the appropriate fields associated with a source cell.

In operation 3, the target node sends an SHR configuration to the source node. This SHR configuration pertains to target cells served by the target node, and as such can be considered a “second partial SHR configuration” that is complementary to the first partial SHR configuration discussed above. The second particular SHR configuration can include any of the information discussed above in relation to FIG. 5 operation 1. In operation 4, the source node forwards the second partial SHR configuration received in operation 3 to the UE.

In some embodiments, the second partial SHR configuration can be a UE-specific SHR configuration sent in response to a HO request sent by the source node to the target node (not shown in FIG. 6). Such embodiments provide flexibility for UE-specific SHR configuration based on UE-specific properties, capabilities, radio conditions, mobility states, etc.

In other embodiments, the second partial SHR configuration sent from target to source can be part of an exchange between these two nodes during an interface (e.g., X2, Xn) setup procedure and/or configuration update procedure such as specified in 3GPP TS 38.423. In such case, the SHR configuration sent by the target node is generic rather than UE-specific. Such embodiments reduces the overhead of sending SHR configurations between nodes relative to UE-specific configuration, at the expense of reduced flexibility.

In other embodiments, the target node can send the second partial SHR configuration in operation 1 upon receiving a request from the source node. This request may be independent of any UE-specific handover operation.

In some embodiments, the target node can be a candidate target node serving a candidate target cell for a conditional handover of the UE. In these embodiments, the source node can receive a plurality of second partial SHR configurations from a respective plurality of candidate target nodes, with each second partial SHR configuration pertaining to node-specific candidate target cells.

In operation 5, the UE stores the second partial SHR configuration received in operation 4 in the appropriate UE variable, such as VarSucessHO-Config. In other words, the UE stores the second partial SHR configuration in an area in UE memory that is assigned to and/or associated with the variable, i.e., in the appropriate fields associated with a target cell.

Note that operations 3-5 in FIG. 6 can occur before or after operations 1-2 in FIG. 6. In some embodiments, the source node can selectively send the SHR configuration to the UE in a single message (e.g., as in FIG. 5) or in multiple messages (e.g., as in FIG. 6) based on whether the target node provides its relevant (e.g., second partial) SHR configuration before or after the source node sends its relevant (e.g., first partial) SHR configuration to the UE.

While the UE is operating in RRC_CONNECTED state, the UE uses the SHR configuration stored in operations 2 and 5 to trigger sending of a SHR as needed (i.e., when conditions in the SHR configuration are met).

In operation 6, the source node sends the UE a command and/or instruction to leave RRC_CONNECTED state and enter RRC_IDLE or RRC_INACTIVE state. For example, the source node can send the UE an RRCRelease message, which will trigger the UE to release its RRC connection and enter RRC_IDLE state. As another example, the source node can send the UE an RRCSuspend message, which will trigger the UE to suspend its RRC connection and enter RRC_INACTIVE state.

In operation 7, the UE discards the SHR configuration stored in the variable during operations 2 and 5 (i.e., if such information is still stored in the variable and was not discarded earlier). In other words, the UE deletes, overwrites, removes, or otherwise makes unusable the SHR configuration previously stored in the area in UE memory that is assigned to and/or associated with the variable. In some embodiments, operation 7 can be responsive to receiving the command and/or instruction in operation 6. In other words, both operation 7 and entering RRC_IDLE or RRC_INACTIVE are responsive to the command and/or instruction. In other embodiments, operation 6 can be done proximately after entering RRC_IDLE or RRC_INACTIVE.

In some variants, the UE can have different behavior in operation 7 depending on whether the command and/or instruction received in operation 6 was to enter RRC_IDLE state or to enter RRC_INACTIVE state. For example, when the command and/or instruction is for RRC_IDLE, the UE can discard the stored SHR configuration. On the other hand, when the command and/or instruction is for RRC_INACTIVE, the UE can retain (or refrain from discarding) the stored SHR configuration.

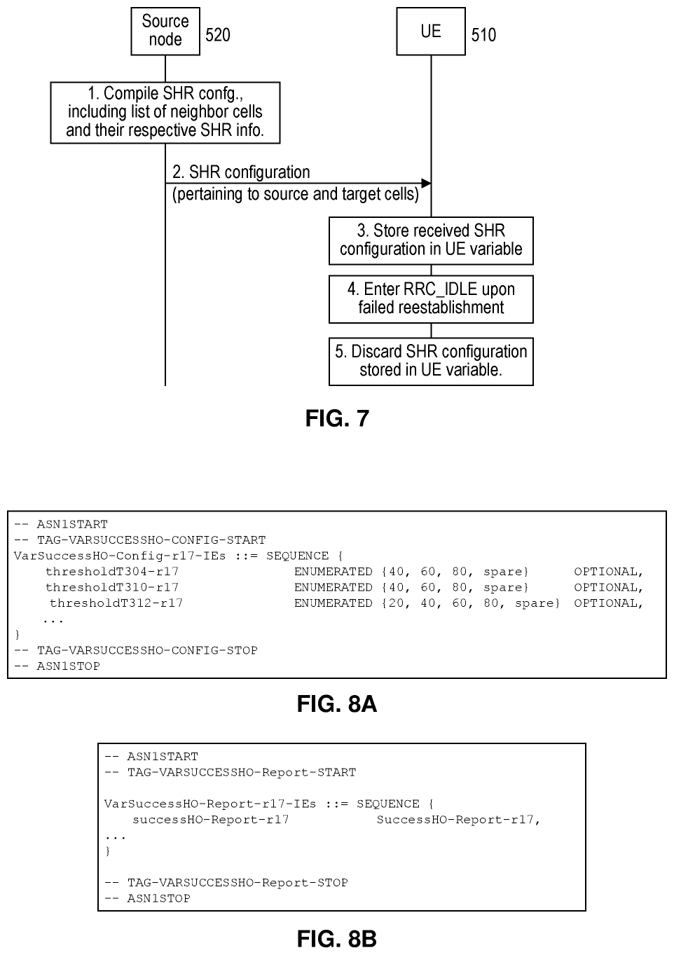

FIG. 7 shows a signaling diagram between a UE (510) and a source node (520) according to other embodiments of the present disclosure. At a high level, these embodiments involve different triggers for the UE to discard a stored SHR configuration than shown in FIGS. 5-6. Although FIG. 7 shows operations with numerical labels, these are intended to facilitate explanation rather than to require and/or imply a sequential order of the operations, unless expressly stated otherwise.

Operations 1-3 can be substantially similar to operations 2-4 shown in FIG. 5. Although not shown, the source node may have previously received from target node(s) SHR configuration information related to target cell(s), based on which the source node performs operation 1.

In operation 4, the UE experiences a radio link failure and then fails to reestablish its connection with the source node, such as due to expiration of a supervision timer such as T311 or T301. The UE then enters RRC_IDLE mode. In operation 5, the UE discards the SHR configuration stored in the variable during operation 3 (i.e., if such information is still stored in the variable and was not discarded earlier). In other words, the UE deletes, overwrites, removes, or otherwise makes unusable the SHR configuration previously stored in the area in UE memory that is assigned to and/or associated with the variable. In some embodiments, operation 5 can be responsive to the reestablishment failure, e.g., expiration of the supervision timer. In other words, both operation 5 and entering RRC_IDLE are responsive to the reestablishment failure. In other embodiments, operation 5 can be done proximately after entering RRC_IDLE state.

Variations of FIG. 7 are also possible. For example, FIG. 7 operation 4 can be used in the signaling diagram of FIG. 6 in place of operation 6.

Various examples of the above-described techniques can also be included in 3GPP specifications. The following exemplary text for 3GPP TS 38.331 gives one such example, with certain less relevant portions of the text being omitted for brevity (shown as ellipses).

```
*** Begin 3GPP TS 38.331 text ***
5.3.11 UE actions upon going to RRC_IDLE
The UE shall:
  1> reset MAC;
  ...
  1> remove all the entries within VarSuccessHO-Config, if any;
  1> remove all the entries within VarConditionalReconfig, if any;
  ...
  1> except if going to RRC_IDLE was triggered by inter-RAT cell reselection while the UE is
    in RRC_INACTIVE or RRC_IDLE or when selecting an inter-RAT cell while T311 was
    running or when selecting an E-UTRA cell for EPS fallback for IMS voice as specified in
    5.4.3.5:
    2> enter RRC_IDLE and perform cell selection as specified in TS 38.304 [20];
*** End 3GPP TS 38.331 text ***
```

FIG. 8A shows an exemplary ASN. 1 data structure for a VarSuccessHO-Config variable in which the UE can store a received SHR configuration for logging of measurements corresponding to a successful handover that will be included in a SHR. In particular, this exemplary variable includes the fields or information elements (IEs) defined in the table below.

| Field name | Description |
|---|---|
| thresholdT304 | Threshold value as a percentage of the signalled |
| | T304 value (ms) |
| thresholdT310 | Threshold value as a percentage of the signalled |
| | T310 value (ms) |
| thresholdT312 | Threshold value as a percentage of the signalled |
| | T312 value (ms) |

FIG. 8B shows an exemplary ASN. 1 data structure for a VarSuccessHO-Report variable in which the UE can store logged information to be sent as SHR.

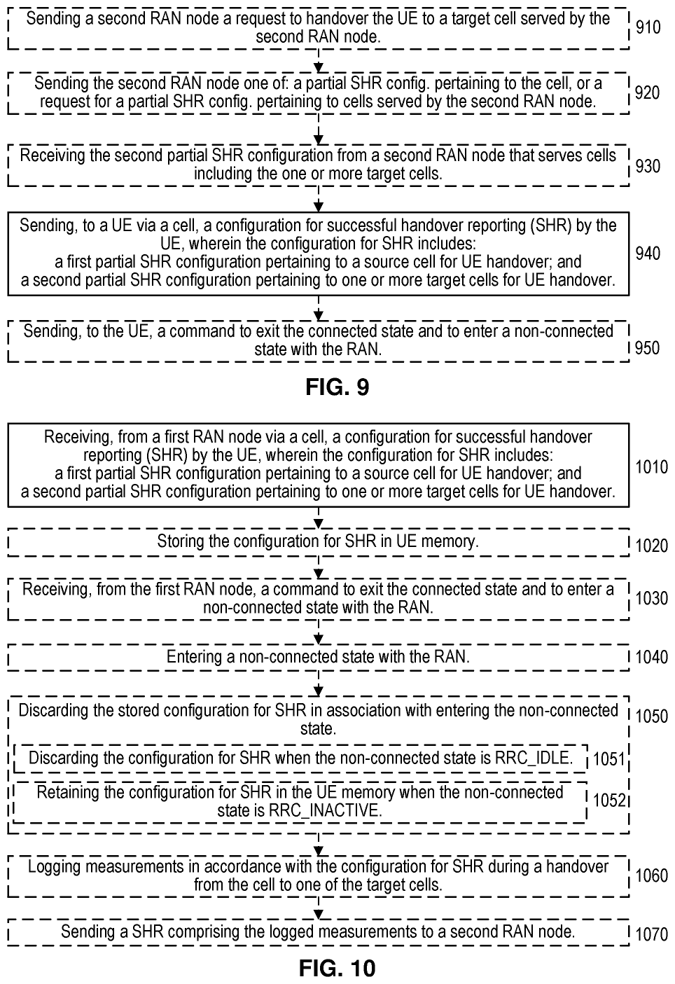

Various features of the embodiments described above correspond to various operations illustrated in FIGS. 9-10, which show exemplary methods (e.g., procedures) for a RAN node and a UE, respectively. In other words, various features of the operations described below correspond to various embodiments described above. Furthermore, the exemplary methods shown in FIGS. 9-10 can be used cooperatively to provide various benefits, advantages, and/or solutions to problems described herein. Although FIGS. 9-10 show specific blocks in particular orders, the operations of the exemplary methods can be performed in different orders than shown and can be combined and/or divided into blocks having different functionality than shown. Optional blocks or operations are indicated by dashed lines.

In particular, FIG. 9 shows an exemplary method (e.g., procedure) for a first RAN node configured to communicate with UEs via a cell, according to various embodiments of the present disclosure. The exemplary method can be performed by a RAN node (e.g., base station, eNB, gNB, ng-eNB, TRP, etc.) such as described elsewhere herein.

The exemplary method can include the operations of block 940, where the first RAN node can send, to a UE via the cell, a configuration for successful handover reporting (SHR) by the UE. The SHR configuration includes a first partial SHR configuration pertaining to a source cell for UE handover, and a second partial SHR configuration pertaining to one or more target cells for UE handover.

In some embodiments, the SHR configuration is valid only while the UE is in a connected state with the RAN. The exemplary method also includes the operations of block 950, where the first RAN node sends, to the UE, a command to exit the connected state and to enter a non-connected state with the RAN. In some of these embodiments, the non-connected state is RRC_IDLE or RRC_INACTIVE, such that the command is (or is included in) an RRCRelease message or an RRCSuspend message, respectively. In some of these embodiments, the command indicates that the UE should discard the SHR configuration if it is stored by the UE.

In some embodiments, the cell (e.g., served by the first RAN node) is the source cell for UE handover and the exemplary method also includes the operations of block 940, where the first RAN node can receive the second partial SHR configuration from a second RAN node that serves cells including the one or more target cells.

In some of these embodiments, the second partial SHR configuration is specific to the UE, and is received (e.g., in block 930) in response to the operations of block 910, where the first RAN node sends the second RAN node a request to handover the UE to one of the target cells.

In other of these embodiments, the second partial SHR configuration is non-specific to the UE, and is received (e.g., in block 930) in response to the operations of block 920, where the first RAN node sends the second RAN node one of the following:
a partial SHR configuration pertaining to one or more cells served by the first RAN node, including the cell; or
a request for a partial SHR configuration pertaining to cells served by the second RAN node, including the one or more target cells.

In some embodiments, the SHR configuration is sent to the UE in a single message. In other embodiments, the first and second partial SHR configurations are sent to the UE in respective first and second messages. In some variants, each of the single message, the first message, and the second message (i.e., the specific message(s) sent to the UE) is an RRCReconfiguration message.

In some embodiments, the second partial SHR configuration includes respective identifiers of the one or more target cells. In some embodiments, the first partial SHR configuration includes respective first thresholds for one or more timers associated with the cell (e.g., T310, T312). In some embodiments, the second partial SHR configuration includes respective second thresholds for respective timers (e.g., T304) associated with the one or more target cells. In some of these embodiments, the respective first thresholds and/or the respective second thresholds are percentages or fractions of corresponding timer values that are configured for the respective cells.

In addition, FIG. 10 shows an exemplary method (e.g., procedure) for a UE configured to communicate with a first RAN node via a cell, according to various embodiments of the present disclosure. The exemplary method can be performed by a UE (e.g., wireless device, etc.) such as described elsewhere herein.

The exemplary method can include the operations of block 1010, where the UE can receive, from the first RAN node via the cell, a configuration for SHR by the UE. The configuration for SHR includes a first partial SHR configuration pertaining to a source cell for UE handover, and a second partial SHR configuration pertaining to one or more target cells for UE handover.

In some embodiments, the configuration for SHR is valid only while the UE is in a connected state with the RAN. In some of these embodiments, the exemplary method also includes the operations of blocks 1020 and 1040-1050, where the UE can store the SHR configuration in UE memory (e.g., in VarSuccessHO-Config), subsequently enter a non-connected state with the RAN, and discard the SHR configuration stored in the UE memory in association with entering the non-connected state.

In some of these embodiments, the exemplary method can also include the operations of block 1030, where the UE can receive, from the first RAN node, a command (e.g., an RRCRelease message or an RRCSuspend message) to exit the connected state and to enter a non-connected state with the RAN. In such case, entering the non-connected state (e.g., in block 1030) is responsive to the command and discarding the SHR configuration (e.g., in block 1050) is responsive to the command or, alternately, to entering the non-connected state. FIGS. 5-6 show examples of these embodiments. In some variants, the command indicates that the UE should discard the SHR configuration if it is stored by the UE.

In other of these embodiments, entering the non-connected state (e.g., in block 1040) is responsive to a failure to reestablish a connection with the RAN, e.g., after an RLF. Additionally, discarding the SHR configuration (e.g., in block 1050) is responsive to the failure or, alternately, to entering the non-connected state. FIG. 7 shows an example of these embodiments.

In some embodiments, discarding the SHR configuration in block 1050 includes the operations of sub-blocks 1051-1052, where the UE can discard the SHR configuration when the non-connected state is RRC_IDLE and retain (i.e., refrain from discarding) the SHR configuration in the UE memory when the non-connected state is RRC_INACTIVE. An opposite convention for the discarding operations with respect to these two states is also possible.

In some embodiments, the SHR configuration is received by the UE in a single message. In other embodiments, the first and second partial SHR configurations are received by the UE in respective first and second messages. In some variants, each of the single message, the first message, and the second message (i.e., the message(s) received by the UE) is an RRCReconfiguration message.

In some embodiments, the second partial SHR configuration includes respective identifiers of the one or more target cells. In some embodiments, the first partial SHR configuration includes respective first thresholds for one or more timers associated with the cell (e.g., T310, T312). In some embodiments, the second partial SHR configuration includes respective second thresholds for respective timers (e.g., T304) associated with the one or more target cells. In some of these embodiments, the respective first thresholds and/or the respective second thresholds are percentages or fractions of corresponding timer values that are configured for the respective cells.

In some embodiments, the exemplary method can also include the operations of blocks 1060-1070, where the UE can log measurements in accordance with the SHR configuration (i.e., stored in block 1020) during a handover from the cell to one of the target cells and send a SHR comprising the logged measurements to a second RAN node (e.g., that serves the target cells). In some of these embodiments, logging measurements in block 1060 is responsive to one or more UE timers exceeding corresponding threshold values included in the configuration for SHR.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

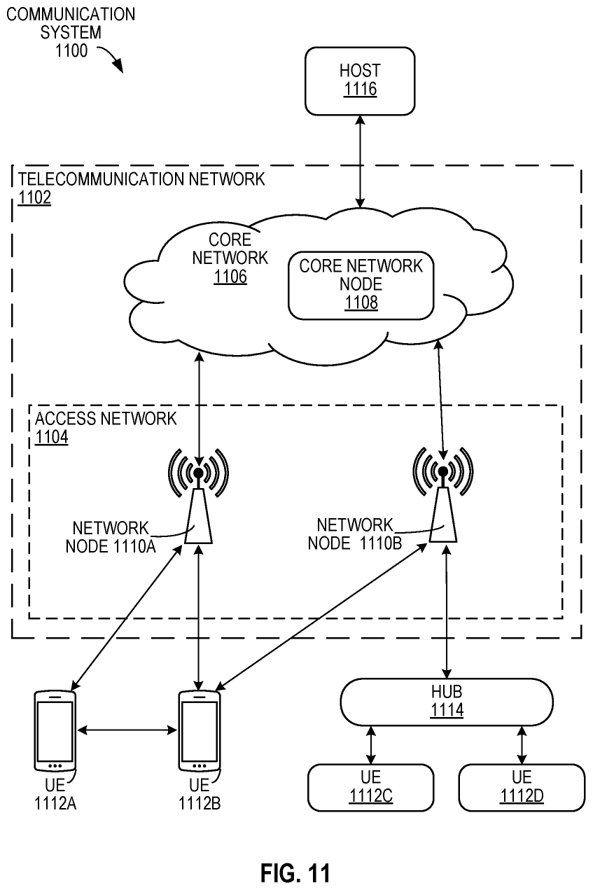

FIG. 11 shows an example of a communication system 1100 in accordance with some embodiments. In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of UEs, such as by connecting UEs 1112a-d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

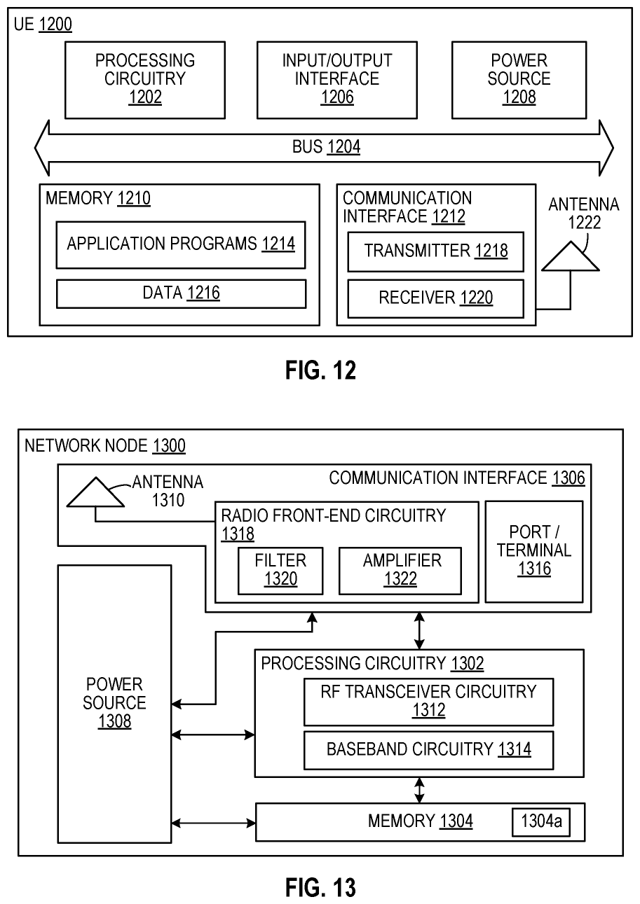

FIG. 12 shows a UE 1200 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. Examples of network nodes include, but are not limited to, access points (e.g., radio access points) and base stations (e.g., radio base stations, Node Bs, eNBs, gNBs, etc.). Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

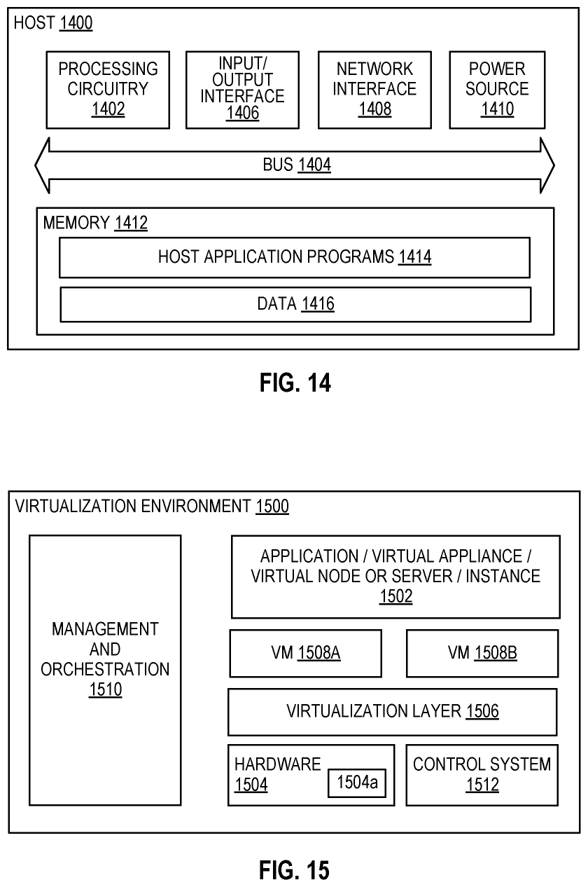

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

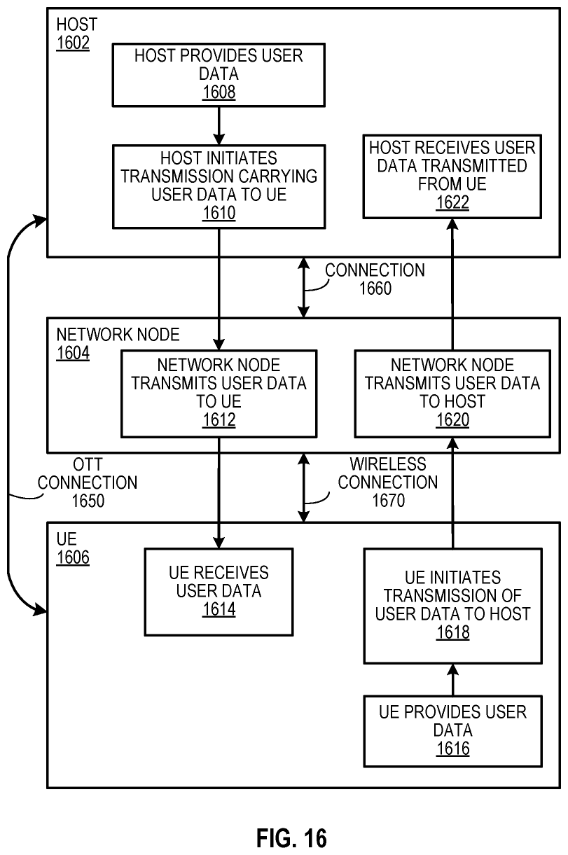

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, embodiments described herein facilitate UE successful handover reporting (SHR) according to a well-defined SHR configuration while in RRC_CONNECTED state, while avoiding inconsistent and/or undesirable UE behavior upon moving from RRC_CONNECTED state to RRC_IDLE or RRC_INACTIVE state. Availability of useful SHR information facilitates network operational improvements that can benefit UEs performing subsequent handovers. When networks and UEs improved in this manner are used to deliver OTT services, they increase the value of such services to end users and service providers.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a first radio access network (RAN) node configured to communicate with user equipment (UEs) via a cell, the method comprising:
sending, to a UE via the cell, a configuration for successful handover reporting (SHR) by the UE, wherein the SHR configuration includes:
   a first partial SHR configuration pertaining to a source cell for UE handover; and
   a second partial SHR configuration pertaining to one or more target cells for UE handover.
      A2. The method of embodiment A1, wherein:
the cell is the source cell; and
the method further comprises receiving the second partial SHR configuration from a second RAN node that serves cells including the one or more target cells.
   A3. The method of embodiment A2, wherein the second partial SHR configuration is specific to the UE, and is received in response to sending the second RAN node a request to handover the UE to one of the target cells.
   A4. The method of embodiment A2, wherein the second partial SHR configuration is non-specific to the UE, and is received in response to sending the second RAN node one of the following:
a partial SHR configuration pertaining to one or more cells served by the first RAN node, including the cell; or
a request for a partial SHR configuration pertaining to cells served by the second RAN node, including the one or more target cells.
   A5. The method of any of embodiments A1-A4, wherein one of the following applies:
the SHR configuration is sent to the UE in a single message; or
the first and second partial SHR configurations are sent to the UE in respective first and second messages.
   A6. The method of embodiment A5, wherein each of the single message, the first message, and the second message is an RRCReconfiguration message.
   A7. The method of any of embodiments A1-A6, wherein one or more of the following applies:
the first partial SHR configuration includes respective first thresholds for one or more timers associated with the cell; and
the second partial SHR configuration includes respective second thresholds for respective timers associated with the one or more target cells.
   A8. The method of embodiment A7, wherein the respective first thresholds and/or the respective second thresholds are percentages or fractions of corresponding timer values that are configured for the respective cells.
   A9. The method of any of embodiments A1-A8, wherein the second partial SHR configuration includes respective identifiers of the one or more target cells.
   A10. The method of any of embodiments A1-A9, wherein the SHR configuration is valid while the UE is in a connected state with the RAN, and the method further comprises sending, to the UE, a command to exit the connected state and to enter a non-connected state with the RAN.
   A11. The method of embodiment A10, wherein the non-connected state is RRC_IDLE or RRC_INACTIVE.
   A12. The method of any of embodiments A10-A11, wherein the command indicates that the UE should delete the SHR configuration if stored by the UE.
   B1. A method for a user equipment (UE) configured to communicate with a first radio access network (RAN) node via a cell, the method comprising:
receiving, from the first RAN node via the cell, a configuration for successful handover reporting (SHR) by the UE, wherein the SHR configuration includes:
   a first partial SHR configuration pertaining to a source cell for UE handover, and
   a second partial SHR configuration pertaining to one or more target cells for UE handover; and
storing the SHR configuration in UE memory.
   B2. The method of embodiment B1, wherein the SHR configuration is valid while the UE is in a connected state with the RAN, and the method further comprises:
entering a non-connected state with the RAN; and
deleting the SHR configuration stored in the UE memory in association with entering the non-connected state.
   B3. The method of embodiment B2, wherein:
the method further comprises receiving, from the first RAN node, a command to exit the connected state and to enter a non-connected state with the RAN;
entering the non-connected state is responsive to the command; and
deleting the SHR configuration is responsive to one of the following: the command, or entering the non-connected state.
   B3a. The method of embodiment B3, wherein the command indicates that the UE should delete the SHR configuration if stored by the UE.
   B4. The method of embodiment B2, wherein:
entering the non-connected state with the RAN is responsive to a failure to reestablish a connection with the RAN; and
deleting the SHR configuration is responsive to one of the following: the failure, or entering the non-connected state.
   B5. The method of any of embodiments B2-B4, wherein deleting the SHR configuration further comprises:
deleting the SHR configuration when the non-connected state is RRC_IDLE; and
retaining the SHR configuration in the UE memory when the non-connected state is RRC_INACTIVE.
   B6. The method of any of embodiments B1-B5, wherein one of the following applies:
the SHR configuration is received by the UE in a single message; or
the first and second partial SHR configurations are received by the UE in respective first and second messages.
   B7. The method of embodiment B6, wherein each of the single message, the first message, and the second message is an RRCReconfiguration message.
   B8. The method of any of embodiments B1-B7, wherein one or more of the following applies:
the first partial SHR configuration includes respective first thresholds for one or more timers associated with the cell; and
the second partial SHR configuration includes respective second thresholds for respective timers associated with the one or more target cells.
   B9. The method of embodiment B8, wherein the respective first thresholds and/or the respective second thresholds are percentages or fractions of corresponding timer values that are configured for the respective cells.
   B10. The method of any of embodiments B1-B9, wherein the second partial SHR configuration includes respective identifiers of the one or more target cells.
   B11. The method of any of embodiments B1-B10, further comprising:
logging measurements in accordance with the SHR configuration during a handover from the cell to one of the target cells; and
sending a SHR comprising the logged measurements to a second RAN node.
   C1. A first radio access network (RAN) node configured to communicate with user equipment (UEs) via a cell, the first RAN node comprising:
communication interface circuitry configured to communicate with UEs and with a second RAN node; and
processing circuitry operatively coupled to the communication interface circuitry, whereby the processing circuitry and the communication interface circuitry are configured to perform operations corresponding to any of the methods of embodiments A1-A12.
   C2. A first radio access network (RAN) node configured to communicate with user equipment (UEs) via a cell, the first RAN node being further configured to perform operations corresponding to any of the methods of embodiments A1-A12.
   C3. A non-transitory, computer-readable medium storing computer-executable instructions that, when executed by processing circuitry of a first radio access network (RAN) node configured to communicate with user equipment (UEs) via a cell, configure the first RAN node to perform operations corresponding to any of the methods of embodiments A1-A12.
   C4. A computer program product comprising computer-executable instructions that, when executed by processing circuitry of a first radio access network (RAN) node configured to communicate with user equipment (UEs) via a cell, configure the first RAN node to perform operations corresponding to any of the methods of embodiments A1-A12.
   D1. A user equipment (UE) configured to communicate with a first radio access network (RAN) node via a cell, the UE comprising:
communication interface circuitry configured to communicate with at least the first RAN node; and
processing circuitry operatively coupled to the radio transceiver circuitry, whereby the processing circuitry and the radio transceiver circuitry are configured to perform operations corresponding to any of the methods of embodiments B1-B11.
   D2. A user equipment (UE) configured to communicate with a first radio access network (RAN) node via a cell, the UE being further configured to perform operations corresponding to any of the methods of embodiments B1-B11.
   D3. A non-transitory, computer-readable medium storing computer-executable instructions that, when executed by processing circuitry of a user equipment (UE) configured to communicate with a first radio access network (RAN) node via a cell, configure the UE to perform operations corresponding to any of the methods of embodiments B1-B11.
   D4. A computer program product comprising computer-executable instructions that, when executed by processing circuitry of a user equipment (UE) configured to communicate with a first radio access network (RAN) node via a cell, configure the UE to perform operations corresponding to any of the methods of embodiments B1-B11.

1.-37. (canceled)

38. A method for a user equipment (UE) configured to communicate with a first radio access network (RAN) node via a cell, the method comprising:
receiving, from the first RAN node via the cell, a configuration for successful handover reporting (SHR) by the UE, wherein the configuration for SHR includes:
a first partial SHR configuration pertaining to a source cell for UE handover, and
a second partial SHR configuration pertaining to one or more target cells for UE handover.

39. The method of claim 38, further comprising:
storing the received configuration for SHR in UE memory;
subsequently entering a non-connected state with the RAN; and
discarding the stored configuration for SHR in association with entering the non-connected state.

40. The method of claim 39, wherein:
the method further comprises receiving, from the first RAN node, a command to exit the connected state and to enter a non-connected state with the RAN;
entering the non-connected state with the RAN is responsive to the command; and
discarding the stored configuration for SHR is responsive to one of the following: the command, or entering the non-connected state.

41. The method of claim 40, wherein the command indicates that the UE should discard the configuration for SHR if it is stored by the UE.

42. The method of claim 39, wherein:
entering the non-connected state with the RAN is responsive to a failure to reestablish a connection with the RAN; and
discarding the stored configuration for SHR is responsive to one of the following: the failure, or entering the non-connected state.

43. The method of claim 39, wherein discarding the stored configuration for SHR further comprises:
discarding the stored configuration for SHR when the non-connected state is RRC_IDLE; and
retaining the stored configuration for SHR in the UE memory when the non-connected state is RRC_INACTIVE.

44. The method of claim 38, wherein one of the following applies:
the configuration for SHR is received by the UE in a single message; or
the first and second partial SHR configurations are received by the UE in respective first and second messages.

45. The method of claim 44, wherein each of the single message, the first message, and the second message is an RRCReconfiguration message.

46. The method of claim 38, wherein one or more of the following applies:
the first partial SHR configuration includes respective first thresholds for one or more timers associated with the cell; and
the second partial SHR configuration includes, for each target cell, respective second thresholds for one or more timers associated with the target cell.

47. The method of claim 46, wherein the respective first thresholds and/or the respective second thresholds are percentages or fractions of respective timer values that are configured for the associated cells.

48. The method of claim 38, wherein the second partial SHR configuration includes respective identifiers of the one or more target cells.

49. The method of claim 38, further comprising:
logging measurements in accordance with the configuration for SHR during a handover from the source cell to one of the target cells; and
sending to a second RAN node a successful handover report comprising the logged measurements.

50. The method of claim 49, wherein logging measurements is responsive to one or more UE timers exceeding corresponding threshold values included in the configuration for SHR.

51. A method for a first radio access network (RAN) node configured to communicate with user equipment, UEs, via a cell, the method comprising:
sending, to a UE via the cell, a configuration for successful handover reporting (SHR) by the UE, wherein the configuration for SHR includes:
a first partial SHR configuration pertaining to a source cell for UE handover; and
a second partial SHR configuration pertaining to one or more target cells for UE handover.

52. The method of claim 51, wherein:
the configuration for SHR is valid only while the UE is in a connected state with the RAN; and
the method further comprises sending, to the UE, a command to exit the connected state and to enter a non-connected state with the RAN, wherein the command indicates that the UE should discard the configuration for SHR if it is stored by the UE.

53. The method of claim 51, wherein:
the cell is the source cell; and
the method further comprises receiving the second partial SHR configuration from a second RAN node that serves cells including the one or more target cells.

54. The method of claim 53, wherein the second partial SHR configuration is specific to the UE, and is received in response to sending the second RAN node a request to handover the UE to one of the target cells.

55. The method of claim 53, wherein the second partial SHR configuration is non-specific to the UE, and is received in response to sending the second RAN node one of the following:
a partial SHR configuration pertaining to one or more cells served by the first RAN node, including the source cell; or
a request for a partial SHR configuration pertaining to cells served by the second RAN node, including the one or more target cells.

56. The method of claim 51, wherein one of the following applies:
the configuration for SHR is sent to the UE in a single message; or
the first and second partial SHR configurations are sent to the UE in respective first and second messages.

57. A user equipment (UE) configured to communicate with a first radio access network (RAN) node via a cell, the UE comprising:
communication interface circuitry configured to communicate with at least the first RAN node; and
processing circuitry operatively coupled to the communication interface circuitry, whereby the processing circuitry and the communication interface circuitry are configured to:
receive, from the first RAN node via the cell, a configuration for successful handover reporting (SHR) by the UE, wherein the configuration for SHR includes:
a first partial SHR configuration pertaining to a source cell for UE handover, and
a second partial SHR configuration pertaining to one or more target cells for UE handover.

58. The UE of claim 57, wherein the processing circuitry and the communication interface circuitry are further configured to:
store the configuration for SHR in UE memory;
receive, from the first RAN node, a command to exit the connected state and to enter a non-connected state with the RAN;
enter the non-connected state in response to the command; and
discarding the stored configuration for SHR responsive to one of the following: the command, or entering the non-connected state.

59. A first radio access network (RAN) node configured to communicate with user equipment (UEs) via a cell, the first RAN node comprising:
communication interface circuitry configured to communicate with UEs and with a second RAN node; and
processing circuitry operatively coupled to the communication interface circuitry, whereby the processing circuitry and the communication interface circuitry are configured to:
send, to a UE via the cell, a configuration for successful handover reporting (SHR) by the UE, wherein the configuration for SHR includes:
a first partial SHR configuration pertaining to a source cell for UE handover; and
a second partial SHR configuration pertaining to one or more target cells for UE handover.

60. The first RAN node of claim 59, wherein:
the configuration for SHR is valid only while the UE is in a connected state with the RAN; and
the processing circuitry and the communication interface circuitry are further configured to send to the UE a command to exit the connected state and to enter a non-connected state with the RAN, wherein the command indicates that the UE should discard the configuration for SHR if it is stored by the UE.
